(19) United States
(12) Patent Application Publication
(10) Pub. No.: US 2026/0014814 A1
(43) Pub. Date: Jan. 15, 2026

(54) BICYCLE REAR WHEEL

(71) Applicant: Mariusz KOZAK, Swidnik (PL)

(72) Inventor: Mariusz KOZAK, Swidnik (PL)

(21) Appl. No.: 18/994,363

(22) PCT Filed: Jul. 5, 2023
(86) PCT No.: PCT/IB2023/056963

§ 371 Date: Jan. 14, 2025

(30) Foreign Application Priority Data
Jul. 15, 2022 (PL) P.441744

(51) Int. Cl. B60B 1/00; B60B 27/00; B60B 27/02; B60K 17/02; F16D 41/24

(52) U.S. Cl. CPC B60B 1/003; B60B 27/0031; B60B 27/023; B60K 17/02; F16D 41/24

(57) ABSTRACT

A rear wheel of a bicycle comprising a tire rim with spokes, a hub axle on which at least one chain drive wheel is rotatably mounted, and a one-way clutch assembly. The one-way clutch assembly consists of coaxially arranged: the rim with internal teeth and the disc with at least one hook for engaging the internal tooth, fixed around the circumference of the disc. The rim has an internal radius defining the circle on which the tips of the internal teeth lie, and this radius is greater than the radius of the circle on the disc on which there is a fixation of at least one hook. One of the elements of the one-way clutch assembly: the rim or the disc, is integrated with the chain drive wheel, and the spokes are fixed to the other element of the one-way clutch assembly: the disc or the rim, respectively.

### TECHNICAL FIELD

The subject of the invention is a bicycle rear wheel with spokes.

### BACKGROUND ART

The bicycle rear wheel is typically made of a hub to which a rim with a tire is attached through spokes. The hub consists of a hub axle on which a rotatable hub body is ball-bearing mounted. The body of the hub has flanges for fixing the spokes. On one of the ends of the hub axle, a rotatable clutch body is ball-bearing mounted, with splines for mounting a bicycle cassette consisting of sprockets. The hub also includes a one-way clutch, which is most commonly a roller, ratchet or disc clutch.

The ratchet clutch consists of a rim and pawls. The rim is usually a metal serrated ring with internal teeth, while pawls usually have springs, thanks to which the pawl is pressed against the tooth of the ring, effecting engagement. In such a case, the rim is attached to the hub body, and the pawls to the clutch body. The reverse arrangement is also possible, where the rim is made with external teeth and is attached to the clutch body, and the pawls are in the hub body. One pawl is sufficient for coupling, but the number of engagement points affects the ride, so the aim is to increase the number of engagements. In this solution, the greater the transmitted torque, the greater the force pressing the clutch elements together.

Another type of a bicycle clutch is the disc clutch, made up of two interlocking discs. Both discs have lateral play in relation to their shafts and at the same time are axially coupled with these shafts. Coupling occurs due to the pressure of the discs against each other, which can be achieved e.g. by springs. Such a clutch has a greater ability to transmit torque. The force with which the clutch discs are pressed together depends on the angle of inclination of the tooth and the twisting torque. The pressure can also be achieved by using neodymium magnets.

A rear bicycle wheel hub assembly is known from the publication of the patent de-scription U.S. Pat. No. 10,752,320B2, comprising: a hub axle including a through hole of the axle with a minimum internal diameter equal to or greater than 13 mm; a hub body rotatably mounted on the hub axle around a central axis of rotation; and a gear wheel clutch body rotatably mounted on the hub axle, the clutch body including at least one external splined tooth for engaging the rear gear wheel assembly of the bicycle. This tooth contains a spline that receives the torque generated during pedalling. The splined outer drive surfaces include a radially helical edge that cooperates with the toothed discs. The radially helical edges allow one toothed disc to move relative to the other. The solution is characterized by a small number of interlocking points and a rather complicated structure.

From the publication of the utility model DE202021106715U1 a bicycle hub is known comprising: a central axis serving as the axis of rotation of the bicycle hub; the main body rotatably connected to the central axis; a freewheel pivotally connected to the central axis and designed to get connected to a set of sprockets, the freewheel having multiple splined teeth. The hub comprises a clutch assembly comprising two ratchet discs having teeth and splines respectively for sliding engagement along the longitudinal direction. One of the ratchet discs is connected to the main body so that it can drive the main body to rotate, and the other disc is connected to the one-way clutch so that it can drive the one-way clutch. The clutch assembly includes an adjusting element connected to the second ratchet disc and exerts a force to displace the second ratchet disc, thereby returning the second ratchet disc to its original position. The adjusting element is a spring, a magnet or is made of an clastic material.

The publication of the application CN114055996A discloses the construction of a one-way gear hub and a bicycle. The mechanism includes a hub assembly and a ratchet wheel assembly. The ratchet wheel assembly is mounted by a first engagement mechanism, the ratchet wheel assembly is coupled with the hub assembly by means of a second engagement mechanism. The ratchet wheel assembly is a one-way support structure and includes a ratchet wheel seat and a ratchet wheel sleeve. In the socket of the ratchet wheel there are rolling elements and springs supporting the respective rolling elements. The ratchet wheel sleeve covers the ratchet wheel socket and all springs and rolling elements in the ratchet wheel socket. The springs press the respective rolling element into contact with the ratchet wheel seat and the ratchet wheel sleeve. The structure has a large mass. In addition, there are high radial forces in the structure. As a result, the solution may have a low durability.

U.S. Pat. No. 10,723,174B2 relates to a bicycle freewheel which has two annular bodies. The first annular ferromagnetic body rotates with the bicycle sprockets and includes a first crowned ring gear. The second annular body rotates with the rear wheel of the bicycle and has a second crowned ring gear matching the first crowned ring gear and facing in its direction. The first annular body is axially movable relative to the second annular body between an engagement condition in which the first ring gear is coupled with the second ring gear and a disengagement condition in which they are decoupled. At least one magnetic body is arranged radially outward from the first annular body so that the first annular body in the disengagement condition is at least partially contained within the axial space of the magnetic body.

### Technical Problem

The aim of the invention is to propose a construction of the rear wheel of a bicycle to feature simple construction and quiet operation in the condition in which the elements forming the one-way clutch are not coupled. The simplicity of the design will give the reduction in the number of structural elements, as a result of which the wheel will be lighter, easier to manufacture, more ecological, and its service also will be easier.

### SUMMARY OF INVENTION

The essence of the rear wheel of a bicycle comprising a spoked tire rim, a hub axle on which at least one driving chain wheel is rotatably mounted, and the one-way clutch assembly, is characterised in that the one-way clutch assembly consists of coaxially arranged: a rim with internal teeth and a disc with at least one hook for engaging an internal tooth, fixed on the circumference of the disc. The rim has an internal radius defining a circle on which the tips of the teeth lie, and this radius is greater than the radius of the circle on the disc where a mounting point for at least one hook is located. One of the elements of the one-way clutch assembly: the rim or the disc, is integrated with the chain drive wheel, and spokes are attached to the second element of the one-way clutch assembly: the disc or the rim, respectively.

Preferably, the rim has a thickness of not more than 30 mm and is arranged concentrically with the disc.

Preferably, the rim and the disc have a thickness of not more than 9 mm and are arranged concentrically with respect to each other.

Preferably, the disc comprises a plurality of hooks.

Preferably, the hooks are arranged symmetrically with respect to the axis of the hub.

Preferably, the hooks are loops.

Advantageously, the hook is fixed rigidly on the circumference of the disc with an initial pressing bend for catching the internal tooth of the rim.

As an alternative, there are at least two hooks for engaging one internal tooth of the rim.

Preferably, one end of the hook has a mounting on the first side of the disc and the other end of the hook has a mounting on the other side of the disc, the hooks being fixed at the same attachment point.

Alternatively, at least one hook has both ends attached to the first side of the disc and at least one hook has both ends attached to the other side of the disc, the hooks being attached at the same attachment point and formed with a loop facing the internal tooth so that they mirror each other when fixed at the first and second side.

As an alternative, at least two hooks are attached to the disc with an initial pressing bend, wherein the hooks have different lengths and the difference in the length of the extreme hooks is smaller than the distance between the tops of the internal teeth.

Preferably, the disc has recesses for hooks on its circumference.

Preferably, the side surface of the tooth on the side opposite to the direction of rotation of the rim is concave, and/or the tip of the tooth is shifted towards the bottom of the notch located on the side of the tooth opposite to the direction of rotation of the rim.

Preferably, the rim with internal teeth is one piece with the largest chain drive wheel.

Preferably, the pitch diameter of the rim is not less than 60 mm and not more than

55% of the wheel rim diameter.

As an alternative, the second element of the one-way clutch assembly, the disc or the rim, is integrated with the flange of the hub body and the spokes are attached to the flange.

The essence of the rear wheel of a bicycle comprising the tire rim with the spokes, the hub axle on which at least one chain drive wheel is rotatably mounted, and the one-way clutch assembly, is based on the fact that the one-way clutch assembly consists of coaxially arranged: the disc with external teeth and the rim with at least one hook for engaging the external tooth, fixed on the internal circumference of the rim. The disc has a radius defining a circle on which the tips of the teeth lie, and this radius is smaller than the radius of the circle on the rim where a mounting point for at least one hook is located. One of the elements of the one-way clutch assembly: the rim or the disc, is integrated with the chain drive wheel, and the spokes are attached to the second element of the one-way clutch assembly, the disc or the rim, respectively.

Preferably, the disc has a thickness of not more than 30 mm and is arranged concentrically with the rim.

Preferably, the disc and the rim have a thickness of not more than 9 mm and are arranged concentrically with respect to each other.

Preferably, the rim comprises a plurality of hooks.

Preferably, the hooks are arranged symmetrically with respect to the axis of the hub.

Preferably, the hooks are loops.

Advantageously, the hook is fixed rigidly on the circumference of the rim with an initial pressing bend for catching the external tooth of the disc.

Alternatively, there are at least two hooks for engaging one external tooth of the disc.

Preferably, one end of the hook has a mounting on the first side of the rim and the other end of the hook has a mounting on the other side of the rim, the hooks being fixed at the same attachment point.

Alternatively, at least one hook has both ends attached to the first side of the rim and at least one hook has both ends attached to the other side of the rim, the hooks being attached at the same attachment point and formed with a loop facing the external tooth so that they mirror each other when fixed at the first and second side.

As an alternative, at least two hooks are attached to the rim with an initial pressing bend, wherein the hooks have different lengths and the difference in the length of the extreme hooks is smaller than the distance between the tops of the external teeth.

Preferably, the rim has recesses for hooks on its inner circumference.

Preferably, the side surface of the tooth on the side opposite to the direction of rotation of the disc is concave, and/or the tip of the tooth is shifted towards the bottom of the notch located on the side of the tooth opposite to the direction of rotation of the disc.

Preferably, the pitch diameter of the disc is not less than 60 mm and not more than 55% of the wheel rim diameter.

As an alternative, the second element of the one-way clutch assembly, the disc or the rim, is integrated with the flange of the hub body and the spokes are attached to the flange.

### Advantageous Effects of Invention

Therefore, the solution provides basically two variants of the one-way clutch assembly. In one variant, the clutch assembly consists of coaxially arranged: the rim with internal teeth and the disc with at least one hook for engaging the internal tooth, fixed on the circumference of the disc, in the other variant, the clutch assembly consists of coaxially arranged: the disc with external teeth and the rim with at least one hook for engaging the external tooth, fixed on the inner circumference of the rim. Both variants constitute a solution that simplifies the construction of the hub and the rear wheel of the bicycle. The use of a disc and a rim allows to reduce the number of structural elements, for example, the solution allows the use of a hub body with a simplified structure. A smaller number of elements has an impact on reducing the failure rate. Wheel servicing is made easier. The use of the disc and rim of the indicated design eliminates knocking, which occurs with traditional and known solutions in the disengagement condition of the mechanism. Precisely, the hooks, and especially the hooks made as loops “jumping over” the teeth in the disengagement condition, are much quieter than e.g. pawls in a ratchet or a disc clutch. In addition, it is envisaged in the solution that the element containing the teeth: the disc with external teeth or the rim with internal teeth will have a pitch diameter of not less than 60 mm and not more than 55% of the wheel rim. The use of the disc or rim of such dimensions allows for multiple attachment points to increase the precision of coupling. Many attachment points also increase the reliability and safety of the mechanism-damage to one of the attachment points will not cause the wheel to fail. In addition, contrary to the known solutions, operation of the hooks is based on tension, not compression. Another advantage is that due to the larger than the known dimensions of the clutch elements, the driving force acting on the teeth and hooks is smaller, which further improves the safety of the structure. The use of plurality of hooks, where at least one hook has both ends fixed on the first side of the rim or disc and at least one hook has both ends fixed on the other side of the rim or disc, with the hooks fixed at the same attachment point, makes catching on the tooth more stable. On the other hand, many hooks of different lengths, where the difference in the length of the extreme hooks is smaller than the distance between the tops of the teeth, allows to increase the number of catching points, with the constant number of teeth on the circumference of the disc or rim. This ensures an increase in clutch sensitivity, e.g. with a smaller number of hook attachment points.

### BRIEF DESCRIPTION OF DRAWINGS

The subject of the invention is presented in exemplary embodiments in the drawing, where:

FIG. 1 schematically shows the rear wheel of a bicycle;

FIG. 2 schematically shows a side view of the one-way clutch assembly in the variant with the rim with internal teeth and the disc with hooks;

FIG. 3 schematically shows a cross-section of the wheel in the variant with the rim with internal teeth, integrated with the chain drive wheel;

FIG. 4 schematically shows an enlarged side view of a fragment of the one-way clutch assembly in the variant with the rim with internal teeth and the disc with hooks;

FIG. 5 schematically shows cross-section of the wheel in the variant with the rim with internal teeth, connected to the spokes;

FIG. 6 schematically shows an enlarged side view of a fragment of the one-way clutch assembly in the variant with the rim with internal teeth and the disc with hooks; with the spokes attached to the rim;

FIG. 7 schematically shows a cross-section of the wheel in the variant with the disc with external teeth, integrated with the chain drive wheel;

FIG. 8 schematically shows an enlarged side view of a fragment of the one-way clutch assembly in the variant with the disc with external teeth and the rim with hooks; with the spokes attached to the rim;

FIG. 9 schematically shows a cross-section of the wheel in the variant with the disc with external teeth, the spokes attached to the disc;

FIG. 10 schematically shows an enlarged side view of a fragment of the one-way clutch assembly in the variant with the disc with external teeth and the rim with hooks, with the spokes attached to the disc;

FIG. 11 schematically shows a cross-section of the wheel in the variant with the rim with internal teeth, integrated with the flange of the hub body to which the spokes are attached;

FIG. 12 schematically shows a cross-section of the wheel in the variant with the disc with external teeth, integrated with the flange of the hub body to which the spokes are attached;

FIG. 13 schematically shows the variant of catching one hook by one tooth;

FIG. 14 schematically shows the variant with a plurality of hooks for engaging one internal tooth; the hooks are fixed with an initial pressing bend and have different lengths;

FIG. 15 schematically shows the variant with two hooks for engaging one external tooth; each hook is attached to one side of the disc or rim.

### DESCRIPTION OF EMBODIMENTS

### Example 1

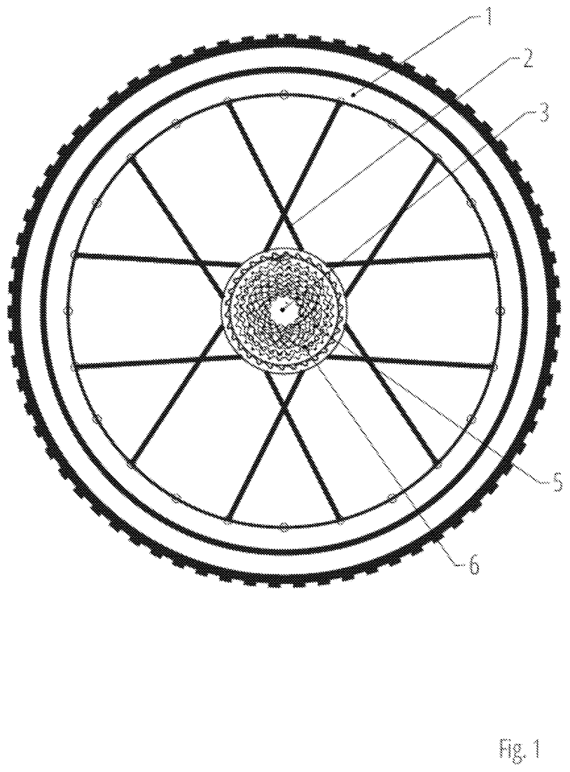

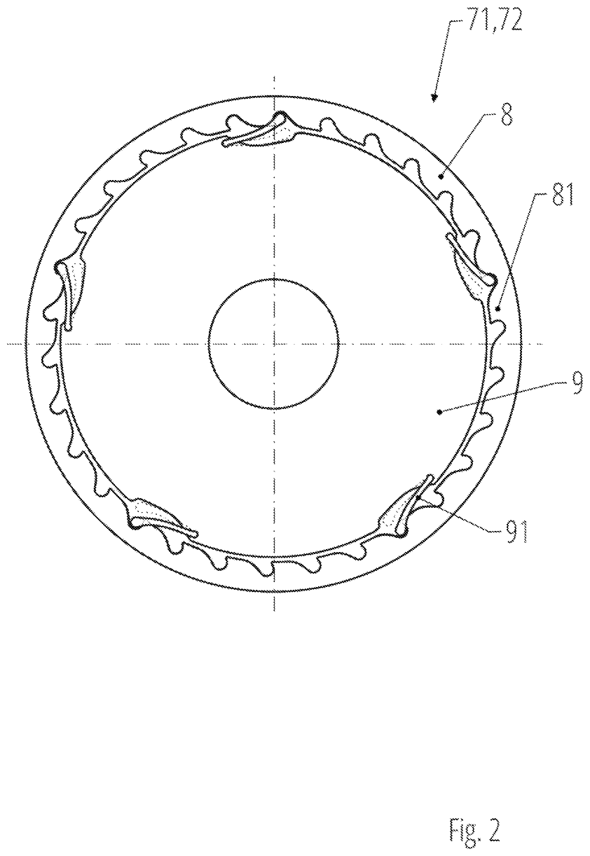

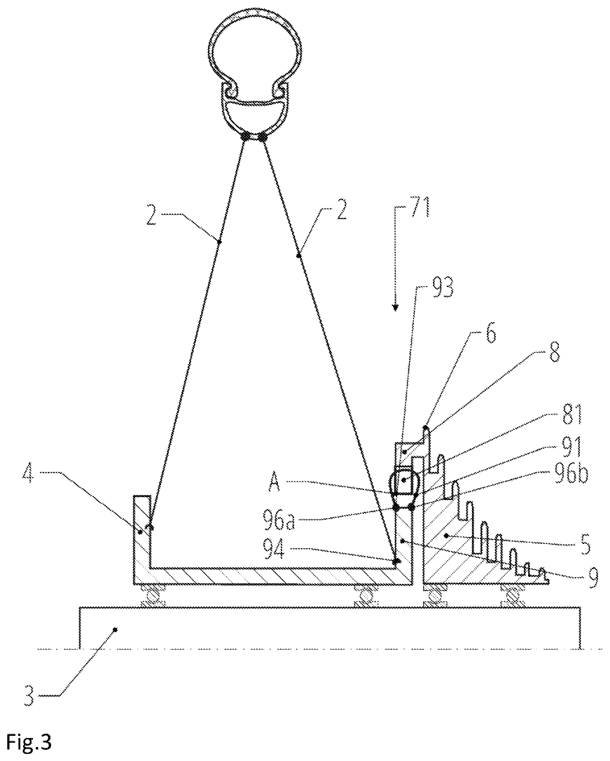

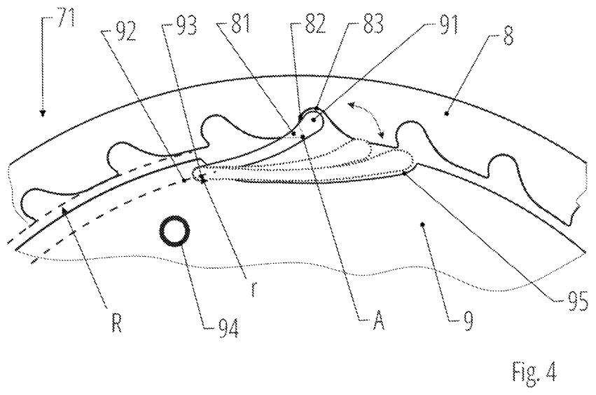

The rear wheel of a bicycle is constructed, as shown in FIG. 1, of the tire rim 1 with spokes 2, the axle 3 of the hub. On the axle 3 of the hub, the following parts are rotatably ball-bearing mounted: the body 4 of the hub and the cassette 5 with the chain drive wheels 6. The wheel includes a one-way clutch assembly 71, shown in FIG. 2-FIG. 4, which consists of coaxially arranged: the rim 8 with internal teeth 81 and the disc 9 with a plurality of hooks 91 for engaging the internal tooth 81. The hook 91 is fixed rigidly on the circumference of the disc 9. The hooks 91 are arranged asymmetrically with respect to the axis 3 of the hub, but in a preferred variant, not shown in the drawing, a symmetrical distribution is designed for the even distribution of forces. The rim 8 has an internal radius R defining the circle on which the tips A of the internal teeth 81 lie, and this radius is greater than the radius r of the circle 92 on the disc 9 on which there is the attachment point 93 for the hooks 91. In this exemplary embodiment, the rim 8 is integrated with the largest chain drive wheel 6. It is also possible, which is not shown in the drawing, to integrate the rim 8 with the largest chain drive wheel 6 in a way that the internal teeth 81 are made on the internal circumference of the largest chain drive wheel 6. The disc 9 is attached to the hub body 4 and has holes 94 for fixing the spokes 2. The rim 8 and the disc 9 have a thickness of 3 mm and are arranged concentrically with respect to each other. The hooks 91 are loops made of a material that yields under pressure. One end of the hook 91 has its fixation 93 on the first side 96a of the disc 9 and the other end of the hook 91 has its fixation on the other side 96b of the disc 9. The hooks 91, which are loops, are fixed on the circumference of the disc 9 with an initial pressing bend to effect catching on the internal tooth 81 of the rim 8. The hook 91 hooked on the tooth 81 effects clutching of the disc 9 and the rim 8 and allows the transmission of torque from the chain drive wheels 6 onto the disc 9 and consequently onto the wheel. When the driven wheel spins faster than the chain drive wheels 6, disengagement takes place and the hook 91 slides off the internal tooth 81. In order to achieve a better and more secure catching effect of the hook 91 on the internal tooth 81, the side surface 82 of the internal tooth 81 on the side opposite to the direction of rotation of the rim 8 is concave and the tip A of the internal tooth 81 is shifted towards the bottom of the notch 83 located on the side of the internal tooth 81 opposite to the direction of rotation of the rim 8. The disc 9 has recesses 95 on its perimeter for hooks 91. In the recesses 95, the hooks 91 are hidden in the disengagement condition. The rim 8 has a pitch diameter greater than 60 mm and less than 55% of the diameter of the rim 1 of the wheel.

### Example 2

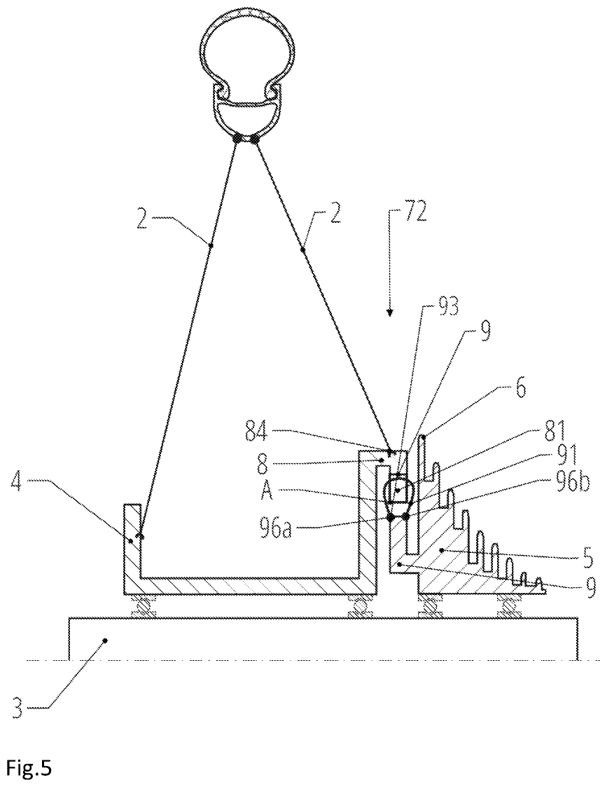

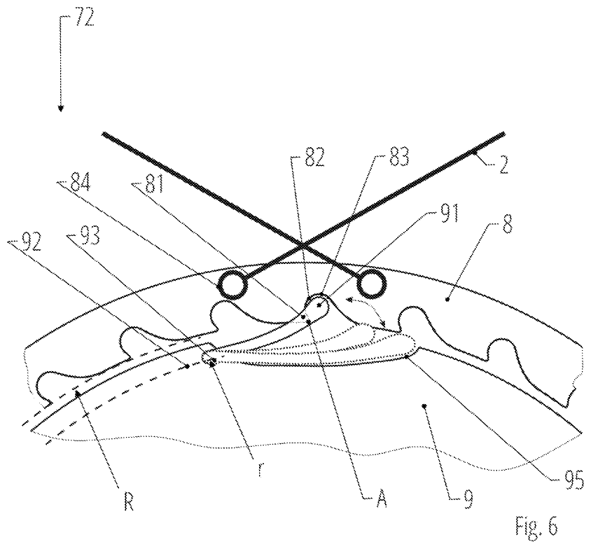

The rear wheel of the bicycle is constructed, as shown in FIG. 1, of the tire rim 1 with spokes 2, the axle 3 of the hub. On the axle 3 of the hub, the following parts are rotatably ball-bearing mounted: the body 4 of the hub and the cassette 5 with the chain drive wheels 6. The wheel includes a one-way clutch assembly 72, shown in FIG. 5, FIG. 6, which consists of coaxially arranged: the rim 8 with internal teeth 81 and the disc 9 with a plurality of hooks 91 for engaging the internal tooth 81. The hook 91 is fixed at the circumference of the disc 9. The hooks 91 are arranged asymmetrically with respect to the axis 3 of the hub, as shown in FIG. 2, but in a preferred variant, not shown in the drawing, a symmetrical distribution is envisaged. The rim 8 has an internal radius R defining the circle on which the tips A of the internal teeth 81 lie, and the radius R is greater than the radius r of the circle 92 on the disc 9 on which there is attachment point 93 for the hooks 91. In this exemplary embodiment, the disc 9 is integrated with the largest chain drive wheel 6 and its diameter is larger than the diameter of the largest chain drive wheel 6. Whereas, the rim 8 is attached to the hub body 4 and has holes 84 for fixing the spokes 2. The rim 8 and the disc 9 have a thickness of 3 mm and are arranged concentrically with respect to each other. The hooks 91 are loops made of a material that yields under pressure. One end of the hook 91 has its fixation 93 on the first side 96a of the disc 9 and the other end of the hook 91 has its fixation on the other side 96b of the disc 9. The hooks 91, which are loops, are fixed on the circumference of the disc 9 with an initial pressing bend to effect catching on the tooth 81 of the rim 8. The hook 91 hooked on the tooth 81 effects clutching of the disc 9 and the rim 8 and allows the transmission of torque from the chain drive wheels 6 onto the rim 8 and consequently onto the wheel. When the driven wheel spins faster than the chain drive wheels 6, disengagement takes place and the hook 91 slides off the tooth 81. In order to achieve a better and more secure catching effect of the hook 91 on the tooth 81, the side surface 82 of the tooth 81 on the side opposite to the direction of rotation of the rim 8 is concave and the tip A of the tooth 81 is shifted towards the bottom of the notch 83 located on the side of the tooth 81 opposite to the direction of rotation of the rim 8. The disc 9 has recesses 96 on its perimeter for hooks 91. In the recesses 96, the hooks 91 are hidden in the disengagement condition. The rim 8 has a pitch diameter greater than 60 mm and less than 55% of the diameter of the rim 1 of the wheel.

### Example 3

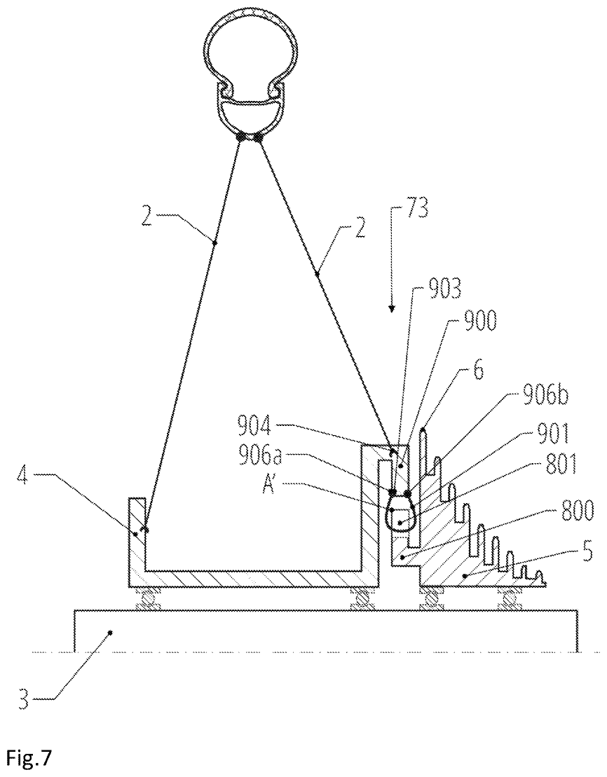

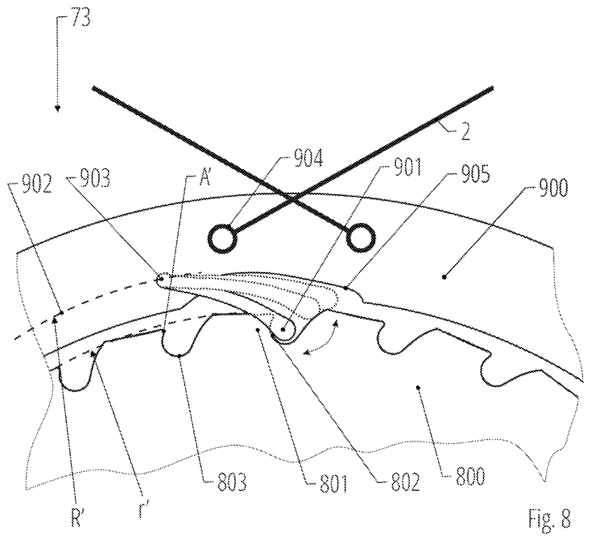

The rear wheel of a bicycle is constructed, as shown in FIG. 1, of the tire rim 1 with spokes 2, the axle 3 of the hub. On the axle 3 of the hub, the following parts are rotatably ball-bearing mounted: the body 4 of the hub and the cassette 5 with the chain drive wheels 6. The wheel includes the one-way clutch assembly 73, shown in FIG. 7, FIG. 8, which consists of coaxially arranged: the disc 800 with external teeth 801 and the rim 900 with a plurality of hooks 901 for engaging the external tooth 801. The hook 901 is fixed rigidly on the inner circumference of the rim 900. The hooks 901 are arranged symmetrically about the axis 3 of the hub, which is not shown in the drawing. The disc 800 has an inside radius r′ defining a circle on which the tips A′ of the external teeth 801 lie and this radius is smaller than the inside radius R′ of the circle 902 on the rim 900 where the fixation 903 of the hooks 901 is placed. In this exemplary embodiment, the disc 800 is integrated with the largest chain drive wheel 6 in such a way that it is attached to it as another toothed gear. The rim 900 is attached to the hub body 4 and has holes 904 for fixing the spokes 2. The rim 900 and the disc 800 have a thickness of 3 mm and are arranged concentrically with respect to each other. The hooks 901 are loops made of a material that yields under pressure. One end of the hook 901 has its fixation 903 on the first side 906a of the rim 900 and the other end of the hook 901 has its fixation on the other side 906b of the rim 900. The hooks 901, which are loops, are fixed on the circumference of the rim 900 with an initial pressing bend to effect catching on the external tooth 801 of the disc 800. The hook 901 hooked on the external tooth 801 effects clutching of the rim 900 and the disc 800 and allows to transfer torque from the chain drive wheels 6 to the rim 900 and consequently to the wheel. When the driven wheel spins faster than the chain drive wheels 6, disengagement occurs and the hook 901 slides off the external tooth 801. In order to achieve a better and more secure catching effect of the hook 901 on the external tooth 801, the side surface 802 of the tooth 801 opposite to the direction of rotation of the disc 800 is concave and the tip A′ of the external tooth 801 is shifted towards the bottom of the notch 803 located on the side of the external tooth 801 opposite to the direction of rotation of the disc 801. The rim 900 has recesses 906 on its perimeter for the hooks 901. In the recesses 906, the hooks 901 are hidden in the disengagement condition. The disc 800 has a pitch diameter greater than 60 mm and less than 55% of the rim 1 diameter of the wheel.

### Example 4

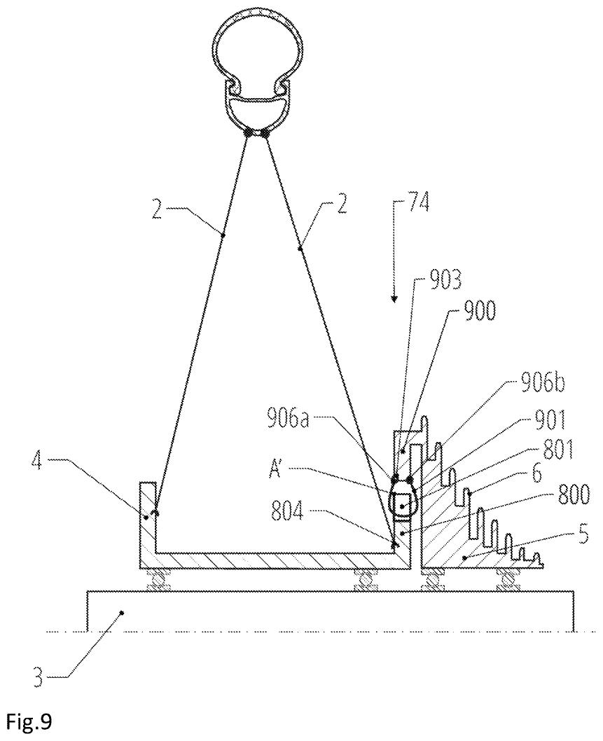

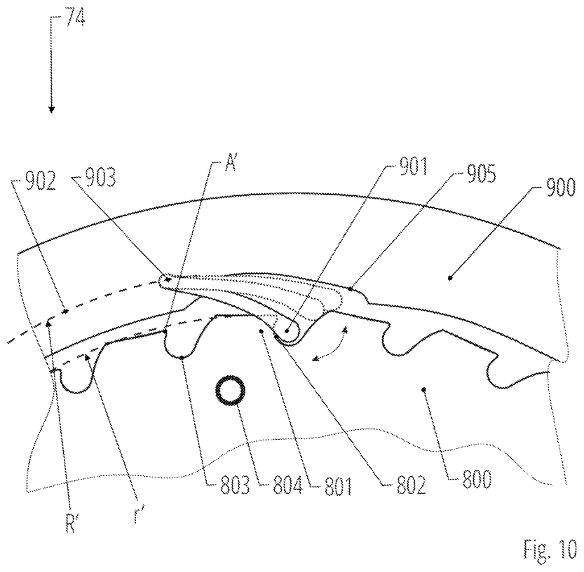

The rear wheel of the bicycle is constructed, as shown in FIG. 1, of the tire rim 1 with spokes 2, the axle 3 of the hub. On the axle 3 of the hub, the following parts are rotatably ball-bearing mounted: the body 4 of the hub and the cassette 5 with the chain drive wheels 6. The wheel includes the one-way clutch assembly 74, shown in FIG. 9, FIG. 10, which consists of coaxially arranged: the disc 800 with external teeth 801 and the rim 900 with a plurality of hooks 901 for engaging the external tooth 801. The hook 901 is fixed on the inner circumference of the rim 900. The hooks 901 are arranged symmetrically with respect to the axis 3 of the hub. The disc 800 has an inside radius r′ defining a circle on which the tips A′ of the external teeth 801 lie and this radius is smaller than the inside radius R′ of the circle 902 on the rim 900 where the fixation 903 of the hooks 901 is placed. In this exemplary embodiment, the rim 900 is integrated with the largest chain drive wheel 6. Whereas, the disc 800 is attached to the hub body 4 and has holes 804 for fixing the spokes 2. The rim 900 and the disc 800 have a thickness of 3 mm and are arranged concentrically with respect to each other. The hooks 901 are loops made of a material that yields under pressure. One end of the hook 901 has its fixation 903 on the first side 906a of the rim 900 and the other end of the hook 901 has its fixation on the other side 906b of the rim 900. The hooks 901, which are loops, are fixed on the circumference of the rim 900 with an initial pressing bend to effect catching on the external tooth 801 of the disc 800. The hook 901 hooked on the external tooth 801 effects clutching of the rim 900 and the disc 800 and enables the transmission of driving rotational force from the chain drive wheels 6 on the disc 800 and consequently on the wheel. When the driven wheel spins faster than the chain drive wheels 6, disengagement occurs and the hook 901 slides off the external tooth 801. In order to achieve a better and more secure catching effect of the hook 901 on the external tooth 801, the side surface 802 of the tooth 801 opposite to the direction of rotation of the disc 800 is concave and the tip A′ of the external tooth 801 is shifted towards the bottom of the notch 803 located on the side of the external tooth 801 opposite to the direction of rotation of the disc 801. The rim 900 has recesses 905 on its perimeter for the hooks 901. In the recesses 905, the hooks 901 are hidden in the disengagement condition. The disc 800 has a pitch diameter greater than 60 mm and less than 55% of the rim I diameter of the wheel.

### Example 5

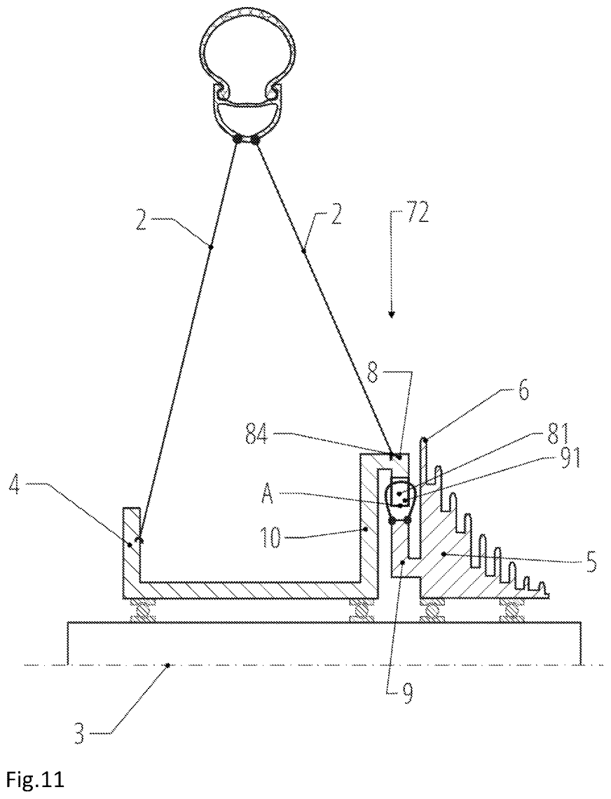

The wheel is made as in Example 2 above, except that the rim 8 of the one-way clutch assembly 72 is integrated with the flange 10 of the hub body 4, as shown in FIG. 11. The spokes 2 are fixed to the flange 10.

### Example 6

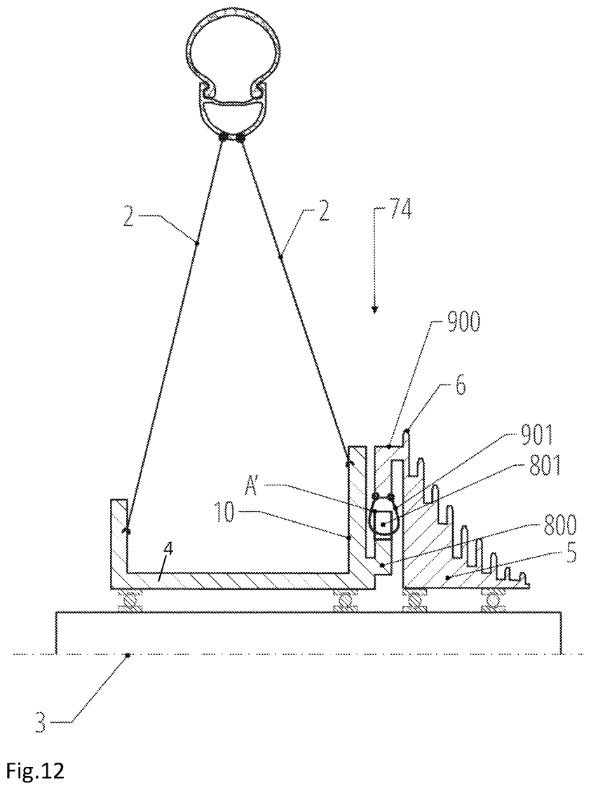

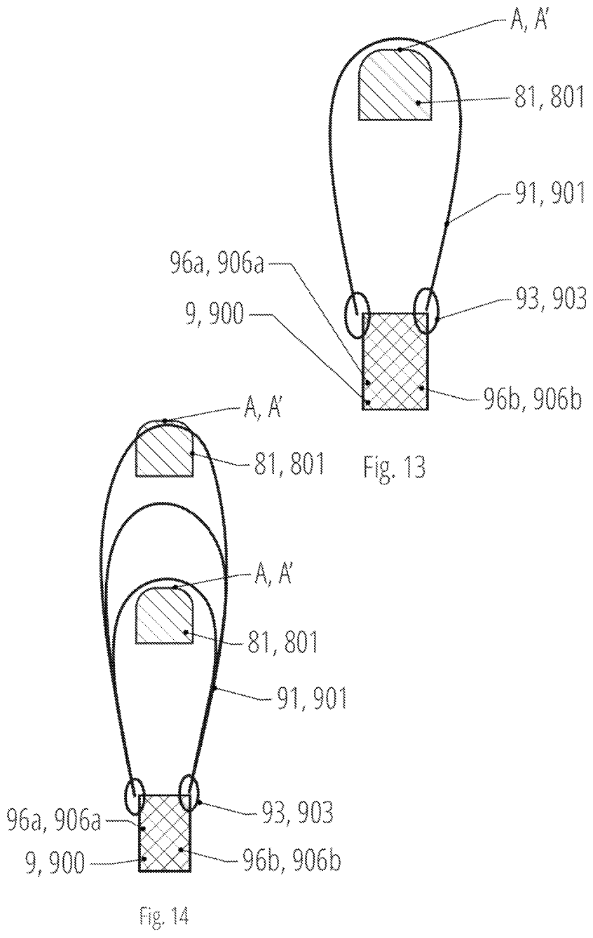

The wheel is made as in Example 4 above, except that the disc 800 of the one-way clutch assembly 74 is integrated with the flange 10 of the hub body 4 as shown in FIG. 12. The spokes 2 are fixed to the flange 10.

### Example 7

The wheel is made according to Examples 1-6 above, except that three hooks 91, 901 in the form of a loop can catch one internal tooth 81 or external tooth 801 (FIG. 14). One end of each hook 91, 901 has its fixation 93, 903 on a first side 96a of the disc 9 or 906a of the rim 900, and the other end of each hook 91, 901 has its fixation on the other side 96b of the disc 9 or 906b of the rim 900. The hooks 91, 901 are attached to the same attachment point 93, 903. The hooks 91, 901 are fixed with an initial pressing bend. The hooks 91, 901 in the form of loops have different lengths, the difference in length of the extreme loops 91, 901 being less than the distance between the tips A or A′ of adjacent teeth 81 or 801. The multiplicity of the hook 91 or 901 makes it possible to multiply catching points.

### Example 8

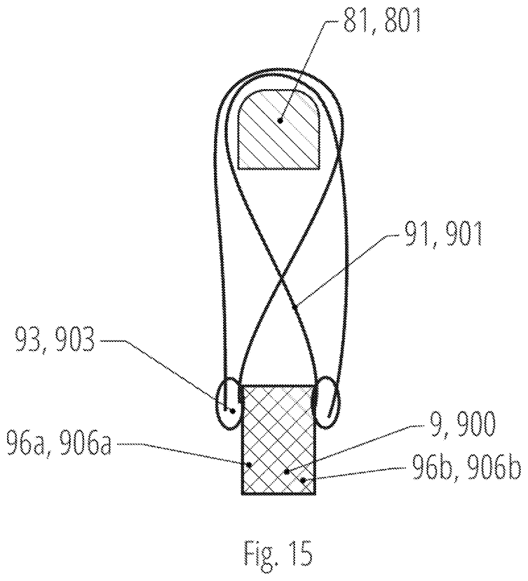

The wheel is made according to Examples 1-6 above, except that two hooks 91 or 901 in the form of loops catch one internal tooth 81 or external tooth 801, as shown in FIG. 15. One hook 91 or 901 has both ends attached to the first side 96a of the disc 9 or 906a of the rim 900 and the other hook 91 or 901 has both ends attached to the other side 96b or 906b of the disc 9 or rim 900. The hooks 91 or 901 are attached to the same attachment point 93 or 903. The hooks 91 or 901 are shaped to have their loops facing the tooth 81 or 801 so that they mirror each other and cross over the tooth 81 or 801 to form a stable hook.

### LIST OF ELEMENTS

| | |
|---|---|
| 1 | rim |
| 2 | spokes |
| 3 | hub axle |
| 4 | hub body |
| 5 | cassette |
| 6 | drive chain wheel |
| 71 | one-way clutch assembly variant 1 |
| 72 | one-way clutch assembly variant 2 |
| 73 | one-way clutch assembly variant 3 |
| 74 | one-way clutch assembly variant 4 |
| 8 | rim |
| 81 | internal tooth |
| 82 | lateral surface of the internal tooth |
| 83 | bottom of the notch |
| 84 | holes in the rim for the spokes |
| 9 | disc |
| 91 | hook |
| 92 | circle on the disc |
| 93 | hook fixation |
| 94 | holes in the disc for the spokes |
| 95 | recess |
| 96a | first side of the disc |
| 96b | the other side of the disc |
| 10 | flange |
| 800 | disc |
| 801 | external tooth |
| 802 | lateral surface of the external tooth |
| 803 | bottom of the notch |
| 804 | holes in the disc for the spokes |
| 900 | rim |
| 901 | hook |
| 902 | circle on the rim |
| 903 | hook fixation |
| 904 | holes in the rim for the spokes |
| 905 | recess |
| 906a | first side of the rim |
| 906b | the other side of the rim |
| A | tip of the internal tooth |
| A′ | tip of the external tooth |
| R | internal radius, defining a circle on the rim on which |
| | the tips of the internal teeth lie |
| r | the radius of the circle on the disc on which the hook is |
| | attached |
| R′ | inner radius of the circle on the rim on which the hook |
| | is attached |
| r′ | the radius that defines a circle on the disc on which the |
| | tips of the external teeth lie |

1. A bicycle rear wheel comprising a tire rim with spokes, a hub axle on which at least one chain drive wheel is rotatably mounted, and a one-way clutch assembly, wherein the one-way clutch assembly consists of coaxially arranged: a rim with internal teeth and a disc with at least one hook for engaging an internal tooth fixed on the perimeter of the disc, wherein the rim has an internal radius defining a circle on which the tips of the internal teeth lie, and this radius is greater than the radius of the circle on the disc at which there is the fixation of at least one hook, and additionally one of the elements of the one-way clutch assembly: the rim or the disc, is combined with the chain drive wheel, and spokes are attached to the second element of the one-way clutch assembly: the disc or the rim, respectively.

2. The rear wheel of a bicycle according to claim 1, wherein the rim has a thickness of not more than 30 mm and is arranged concentrically with the disc.

3. The rear wheel of a bicycle according to claim 1, wherein the rim and the disc have a thickness of not more than 9 mm and are arranged concentrically with respect to each other.

4. The rear wheel of a bicycle according to claim 1, wherein the disc includes a plurality of hooks.

5. The rear wheel of a bicycle according to claim 4, wherein the hooks are arranged symmetrically to the axis of the hub.

6. The rear wheel of a bicycle according to claim 1, wherein the hooks are loops.

7. The rear wheel of a bicycle according to claim 1, wherein the hook is fixed rigidly on the circumference of the disc with an initial pressing bend for catching the internal tooth of the rim.

8. The rear wheel of a bicycle according to claim 1, wherein there are at least two hooks for engaging one internal tooth of the rim.

9. The rear wheel of a bicycle according to claim 8, wherein one end of the hook has its fixation on the first side of the disc and the other end of the hook has its fixation on the other side of the disc, the hooks being fixed at the same attachment point.

10. The rear wheel of a bicycle according to claim 8, wherein at least one hook has both ends attached to the first side of the disc and at least one hook has both ends attached to the other side of the disc, the hooks being attached to the same attachment point and the hooks are shaped to have a loop facing the internal tooth so that they are mirror images of each other when attached to the first and second side (96a, 96b).

11. The rear wheel of a bicycle according to claim 8, wherein least two hooks are attached to the disc with an initial pressing bend, whereas the hooks have different lengths, and the difference in the length of the extreme hooks is smaller than the distance between successive tips (A) of the internal teeth.

12. The rear wheel of a bicycle according to claim 1, wherein the disc has recesses on its circumference for the hooks.

13. The rear wheel of a bicycle according to claim 1, wherein the internal tooth on the side opposite to the direction of rotation of the rim has a concave side surface and/or the tip (A) of the internal tooth is shifted towards the bottom of the notch located on the internal tooth side opposite to the direction of rotation of the rim, and on the side consistent with the direction of rotation of the rim it has a convex side surface.

14. The rear wheel of a bicycle according to claim 1, wherein the rim with the internal teeth is one piece with the largest chain drive wheel.

15. The rear wheel of a bicycle according to claim 1, wherein the pitch diameter of the rim is not less than 60 mm and not more than 55% of the diameter of the rim of the wheel.

16. The rear wheel of a bicycle according to claim 1, wherein the second element of the one-way clutch assembly, the disc or the rim, is integrated with the flange of the hub body and the spokes are attached to the flange.

17. A bicycle rear wheel comprising a tire rim with spokes, a hub axle on which at least one chain drive wheel is rotatably mounted, and a one-way clutch assembly, wherein the one-way clutch assembly consists of coaxially arranged: a disc with external teeth and a rim with at least one hook for engaging the external tooth mounted on the internal circumference of the rim, the disc having a radius (r′) defining a circle on which the tips (A′) of the external teeth lie, and this radius is smaller than the inner radius (R′) of the circle on the rim, on which there is the fixation of at least one hook and, furthermore, one of the elements of the one-way clutch assembly: the rim or the disc, is integrated with the chain drive wheel, and the spokes are attached to the second element of the one-way clutch assembly: the disc or the rim, respectively.

18. The rear wheel of a bicycle according to claim 17, wherein the disc has a thickness of not more than 30 mm and is arranged concentrically with the rim.

19. The rear wheel of a bicycle according to claim 17, wherein the disc and the rim have a thickness of not more than 9 mm and are arranged concentrically with respect to each other.

20. The rear wheel of a bicycle according to claim 1, wherein the rim includes a plurality of hooks.

21. The rear wheel of a bicycle according to claim 20, wherein the hooks are arranged symmetrically to the axis of the hub.

22. The rear wheel of a bicycle according to claim 17, wherein the hooks are loops.

23. The rear wheel of a bicycle according to claim 17, wherein the hook is fixed rigidly on the circumference of the rim with an initial pressure bend to effect the engagement with the external tooth of the disc.

24. The rear wheel of a bicycle according to claim 17, wherein there are at least two hooks for engaging one external tooth of the disc.

25. The rear wheel of a bicycle according to claim 24, wherein one end of the hook has its fixation on the first side (906a) of the rim and the other end of the hook has its fixation on the other side (906b) of the rim, the hooks being fixed at the same attachment point.

26. The rear wheel of a bicycle according to claim 24, wherein at least one hook has both ends attached to a first side of the rim and at least one hook has both ends attached to the other side of the rim, the hooks being fixed at the same attachment point and the hooks are shaped to have a loop facing the external tooth so that they are mirror images of each other when attached to the first and second side (906a, 906b).

27. The rear wheel of a bicycle according to claim 24, wherein at least two hooks are attached to the rim with an initial pressure bend, the hooks being of different lengths and the difference in the length of the extreme hooks being less than the distance between successive tops (A′) of the external teeth.

28. The rear wheel of a bicycle according to claim 17, wherein the rim has recesses on its inner circumference for the hooks.

29. The rear wheel of a bicycle according to claim 17, wherein the external tooth on the side opposite to the direction of rotation of the disc has a concave side surface and/or the tip (A′) of the external tooth is shifted towards the bottom of the notch situated on the external tooth side opposite to the direction of rotation of the disc, and on the side corresponding to the direction of rotation of the disc it has a convex side surface.

30. The rear wheel of a bicycle according to claim 17, wherein the pitch diameter of the disc is not less than 60 mm and not more than 55% of the diameter of the rim of the wheel.

31. The rear wheel of a bicycle according to claim 17, wherein the second element of the one-way clutch assembly, the disc or the rim, is integrated with the flange of the hub body and the spokes are fixed to the flange.
